(19) United States
(12) Patent Application Publication
(10) Pub. No.: US 2006/0183432 A1
(43) Pub. Date: Aug. 17, 2006

(54) Calibration using range of transmit powers

(76) Inventors: Donald Breslin, Santa Clara, CA (US); Jeffrey M. Gilbert, Santa Clara, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(21) Appl. No.: 11/330,716

(22) Filed: Jan. 11, 2006

Related U.S. Application Data
(60) Provisional application No. 60/643,460, filed on Jan. 12, 2005.

(51) Int. Cl. H04B 7/00; H04B 1/00

(52) U.S. Cl. 455/69; 455/522

(57) ABSTRACT

A transmitter can send frames with a range of transmitter powers to another device in a wireless network. The quality metrics computed from these frames can be advantageously used to determine an optimal transmit power. These quality metrics can be computed by the other device or by the transmitter. Each quality metric can include an EVM and, optionally, also an RSSI. The transmitter can calibrate its optimal transmit power using the quality metrics. The optimal transmit power can be a maximum power that meets a minimum quality specification for a given supported modulation format, the transmit power that allows for a greatest path loss while maintaining a given packet error rate (PER), or the transmit power that maximizes a throughput supported in the wireless network.

### RELATED APPLICATIONS

This application claims priority of U.S. Provisional Patent Application 60/643,460, entitled “Calibration Using Receiver-Based EVM Detector” filed Jan. 12, 2005.

### BACKGROUND OF THE INVENTION

1. Field of the Invention

The present invention relates to a wireless network and in particular to a calibration of a transmitter using a range of transmit powers.

2. Related Art

Transmit power calibration is typically performed by a manufacturer with some margin (also called backoff) to account for board-to-board variation and to cover a range of less than optimal environmental conditions (e.g. temperature). Therefore, during live operation, a given wireless device may support a higher transmit power than the calibration specifies.

Note that transmit power calibration is essentially a tradeoff between range and throughput per modulation rate supported. That is, as the transmit power used for a given modulation format is increased the range is extended at the expense of the maximum throughput supported. During live operation, a given device may reduce its transmit power if range extension is not required to increase the maximum throughput provided.

In a common wireless network, a receiver can determine a signal quality of an incoming signal from a transmitter and then transmit that signal quality back to the transmitter. The transmitter can then adjust the power based on that signal quality. Notably, if the signal quality is “acceptable”, then no adjustment is made. Unfortunately, this feedback technique can easily fail to determine an optimal transmitter power.

Therefore, a need arises for a technique that can accurately determine an optimal transmitter power.

### SUMMARY OF THE INVENTION

In accordance with one aspect of the invention, a transmitter can send a plurality of frames with a range of transmitter powers to another device in a wireless network. The quality metrics computed from these frames can be advantageously used to determine an optimal transmit power.

In one method, using the plurality of transmit powers, a receiver can compute quality metrics and send these quality metrics to the transmitter as feedback. Each quality metric can include at least an error vector magnitude (EVM). Note that in some embodiments, each quality metric can further include a received signal strength indicator (RSSI). The transmitter can calibrate its optimal transmit power using the feedback.

In another method, using its own receiver to monitor a plurality of signals, a transceiver (which includes both a transmitter and a receiver) can compute quality metrics. Each quality metric can include at least an EVM (and in some embodiments, an RSSI). Using the quality metrics, the transceiver can calibrate its optimal transmit power.

In one embodiment, the optimal transmit power can be defined as a maximum power that meets a minimum quality specification for a given supported modulation format. In another embodiment, the optimal transmit power can be defined as a transmit power that allows for a greatest path loss while maintaining a given packet error rate (PER). In yet another embodiment, the optimal transmit power can be defined as a transmit power that maximizes a throughput supported in the wireless network.

These calibration steps can be performed during association of the transmitter and the receiver and/or periodically during a connection between the transmitter and the receiver. These techniques can be advantageously computer implemented in wireless devices, e.g. transmitters and transceivers, using instructions.

### BRIEF DESCRIPTION OF THE FIGURES

FIG. 1 illustrates an exemplary technique to calibrate the power of a transmitter. This technique calibrates using a quality metric measured by another device. The quality metric is based on a plurality of frames having a range of transmit powers.

FIG. 2 illustrates another exemplary technique to calibrate the power of a transmitter. This technique calibrates using a quality metric measured by the transmitter itself. The quality metric is based on a plurality of frames having a range of transmit powers.

### DETAILED DESCRIPTION OF THE FIGURES

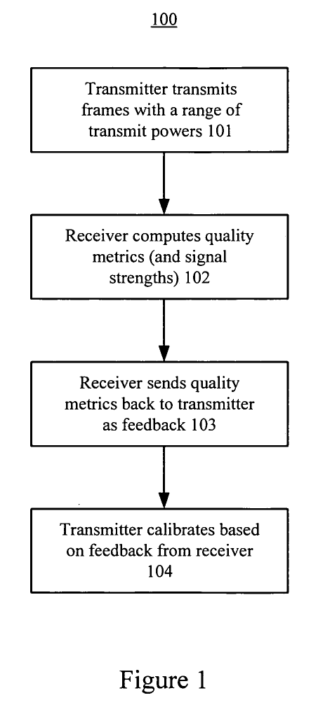

In accordance with one aspect of the invention, a range of transmit powers can advantageously facilitate the optimal calibration of transmitter power. FIG. 1 illustrates an exemplary technique 100 that can be used in a wireless network to provide this transmit power calibration.

To perform technique 100, a wireless network can include a transmit device (transmitter) capable of modifying its transmit power and a receive device (receiver) capable of reporting a quality metric back to the transmitter. This quality metric can include, for example, the error vector magnitude (EVM). In one embodiment, the receive device can also be capable of reporting a signal strength, e.g. the received signal strength indicator (RSSI), back to the transmitter.

Notably, in step 101, the transmitter can transmit a plurality of frames to the receiver using a plurality of transmit powers. For example, the transmitter could use a range of transmit powers from 10 dBm to 30 dBm. This range of transmit powers can advantageously improve the quality of the feedback provided by the receiver.

Specifically, for each frame and associated transmit power, the receiver can compute a quality metric in step 102. In one embodiment, this quality metric can include the error vector magnitude (EVM). In another embodiment, the receiver can also compute the received signal strength, e.g. the received signal strength indicator (RSSI). (Note that a combination of EVM and RSSI can be used to maximize link budget, which can reduce the margin, and throughput.) In step 103, the receiver can report its computation results to the transmitter, thereby allowing the transmitter to calibrate its transmit power based on that feedback in step 104. Note that calibration steps 101-104 can be performed during association and/or periodically throughout the wireless connection between the transmitter and the receiver.

In this calibration, the transmitter can determine its optimal transmit power. The optimal transmit power can be defined as the maximum power that meets the minimum quality specification for a given supported modulation format. Thus, based on the quality metrics, the transmitter can determine the maximum transmit power for its given hardware and environmental conditions, per modulation format supported.

Alternatively, the optimal transmit power can be defined as the transmit power that allows for the greatest path loss while maintaining a given packet error rate (PER). One way to determine the greatest path loss per given PER is by selecting the output power that minimizes the total contribution of the transmitter noise (such as due to non-linearities) as well as the receiver noise. This optimal power will be different depending on the path loss because the path loss impacts the relative impact of the receiver noise. In yet another embodiment, the optimal transmit power can be defined as the power that maximizes the throughput supported on the wireless link.

Note that the transmitter can also reduce its transmit power once it knows that the receiver is receiving a signal that has excess signal such that the signal to noise ratio (SNR) of the receiver is not limited by antenna-referred noise, but rather the internal dynamic range of the transmitter or receiver (or at least the contribution of the internal noises increases relative to that of the external antenna-referred noise). This level can be set heuristically, through manufacturing calibration, or through live calibration.

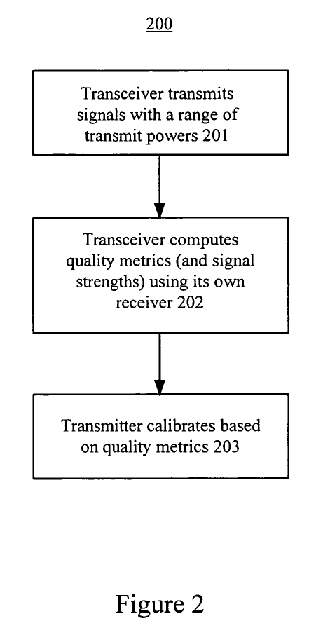

FIG. 2 illustrates another exemplary technique 200 that can be used in a wireless network to provide transmit power calibration. Note that in a typical wireless network each wireless device can include a transceiver, which is capable of both transmitting and receiving RF signals. This dual capability can be effectively leveraged in technique 200.

Specifically, in step 201, the transceiver can transmit a plurality of signals using a plurality of transmit powers. For each signal and associated transmit power, the transceiver can monitor those signals using its own receiver and compute quality metrics based only on those signals (using certain generalized assumptions regarding those quality metrics because another device is not providing feedback) in step 202. In step 203, the transceiver can calibrate its transmit power based on those computed quality metrics. Thus, in technique 200, also called a “loopback” technique, a transceiver can, without feedback from another device, choose its optimal transmit power for given hardware and environmental conditions per modulation format supported.

Although illustrative embodiments of the invention have been described in detail herein with reference to the accompanying figures, it is to be understood that the invention is not limited to those precise embodiments. They are not intended to be exhaustive or to limit the invention to the precise forms disclosed. As such, many modifications and variations will be apparent.

For example, the above-described techniques can be advantageously computer implemented in wireless devices, e.g. transmitters and transceivers, using instructions embodied on a computer readable medium. Accordingly, it is intended that the scope of the invention be defined by the following Claims and their equivalents.

1. A method of calibrating a power of a transmitter, the transmitter forming part of a wireless network, the method comprising:
transmitting a plurality of frames to a receiver in the wireless network using a plurality of transmit powers;
receiving quality metrics from the receiver as feedback, the quality metrics being computed at the receiver using the plurality of frames, each quality metric including at least an error vector magnitude (EVM); and
calibrating an optimal transmit power of the transmitter using the feedback.

2. The method of claim 1, wherein each quality metric further includes a received signal strength indicator (RSSI).

3. The method of claim 1, wherein the optimal transmit power is a maximum power that meets a minimum quality specification for a given supported modulation format.

4. The method of claim 1, wherein the optimal transmit power is a transmit power that allows for a greatest path loss while maintaining a given packet error rate (PER).

5. The method of claim 4, wherein calibrating the optimal transmit power includes selecting the transmit power that minimizes a total contribution of transmitter noise and receiver noise.

6. The method of claim 1, wherein the optimal transmit power is a transmit power that maximizes a throughput supported in the wireless network.

7. The method of claim 1, wherein the steps of transmitting, receiving, and calibrating are performed at least during association of the transmitter and the receiver.

8. The method of claim 1, wherein the steps of transmitting, receiving, and calibrating are performed at least periodically during a connection between the transmitter and the receiver.

9. A method of calibrating a transmit power of a transceiver, the method comprising:
transmitting a plurality of signals using a plurality of transmit powers;
computing quality metrics at the transceiver using only the plurality of signals, each quality metric including at least an error vector magnitude (EVM); and
calibrating an optimal transmit power using the quality metrics.

10. The method of claim 9, wherein each quality metric further includes a received signal strength indicator (RSSI).

11. The method of claim 9, wherein the optimal transmit power is a maximum power that meets a minimum quality specification for a given supported modulation format.

12. The method of claim 9, wherein the optimal transmit power is a transmit power that allows for a greatest path loss while maintaining a given packet error rate (PER).

13. The method of claim 12, wherein calibrating the optimal power includes selecting the transmit power that minimizes transmitter noise.

14. The method of claim 9, wherein the optimal transmit power is a transmit power that maximizes a throughput supported in the wireless network.

15. A transmitter capable of forming part of a wireless network, the transmitter including computer implemented instructions embodied on a computer readable medium, the computer implemented instructions for optimizing transmitter power, the transmitter comprising:
instructions for transmitting a plurality of frames to a receiver in the wireless network using a plurality of transmit powers;
instructions for receiving quality metrics from the receiver as feedback, the quality metrics being computed at the receiver using the plurality of frames, each quality metric including at least an error vector magnitude (EVM); and
instructions for calibrating an optimal transmit power of the transmitter using the feedback.

16. The transmitter of claim 15, wherein each quality metric further includes a received signal strength indicator (RSSI).

17. The transmitter of claim 15, wherein the optimal transmit power is a maximum power that meets a minimum quality specification for a given supported modulation format.

18. The transmitter of claim 15, wherein the optimal transmit power is a transmit power that allows for a greatest path loss while maintaining a given packet error rate (PER).

19. The transmitter of claim 18, wherein the instructions for calibrating the optimal power include instructions for selecting the transmit power that minimizes a total contribution of transmitter noise and receiver noise.

20. The transmitter of claim 15, wherein the optimal power is a transmit power that maximizes a throughput supported in the wireless network.

21. The transmitter of claim 15, wherein the instructions for transmitting, receiving, and calibrating are performed at least during association of the transmitter and the receiver.

22. The transmitter of claim 15, wherein the instructions for transmitting, receiving, and calibrating are performed at least periodically during a connection between the transmitter and the receiver.

23. A transceiver capable of forming part of a wireless network, the transmitter including computer implemented instructions embodied on a computer readable medium, the computer implemented instructions for optimizing transmitter power, the transceiver comprising:
instructions for transmitting a plurality of signals using a plurality of transmit powers;
instructions for computing quality metrics at the transceiver using only the plurality of signals, each quality metrics including at least an error vector magnitude (EVM); and
instructions for calibrating an optimal transmit power using the quality metrics.

24. The transceiver of claim 23, wherein each quality metric further includes a received signal strength indicator (RSSI).

25. The transceiver of claim 23, wherein the optimal transmit power is a maximum power that meets a minimum quality specification for a given supported modulation format.

26. The transceiver of claim 23, wherein the optimal transmit power is a transmit power that allows for a greatest path loss while maintaining a given packet error rate (PER).

27. The transceiver of claim 26, wherein the instructions for calibrating the optimal transmit power include instructions for selecting the transmit power that minimizes transmitter noise.

28. The transceiver of claim 23, wherein the optimal transmit power is a transmit power that maximizes a throughput supported in the wireless network.
